(19) United States
(12) Patent Application Publication
(10) Pub. No.: US 2011/0083526 A1
(43) Pub. Date: Apr. 14, 2011

(54) CONNECTING APPARATUS FOR AN ACTUATING CABLE AS WELL AS MANUAL TRANSMISSION OF A MOTOR VEHICLE WITH THIS CONNECTING APARATUS

(75) Inventors: Thorsten HAHN, Gau-Odernheim (DE); Frank LINDNER, Hattersheim (DE)

(73) Assignee: GM GLOBAL TECHNOLOGY OPERATIONS, INC., Detroit, MI (US)

(21) Appl. No.: 12/882,389

(22) Filed: Sep. 15, 2010

(30) Foreign Application Priority Data
Sep. 16, 2009 (DE) 102009041706.0

(51) Int. Cl. F16C 1/10; F16B 9/00

(52) U.S. Cl. 74/502.4; 403/187

(57) ABSTRACT

A connecting apparatus is provided for an actuating cable on a receiver that includes, but is not limited to a base body, a receiving body for connection to the receiver, two separate housing parts, which surround the receiving body, two damping elements, which are each disposed between one of the housing parts and the base body, and a holder. The holder is displaceably coupled to the housing parts and can be connected to the actuating cable. On actuating the actuating cable, the holder exerts force on a housing part and on a damping element.

### CROSS-REFERENCE TO RELATED APPLICATION

This application claims priority to German Patent Application No. 102009041706.0, filed Sep. 16, 2009, which is incorporated herein by reference in its entirety.

### TECHNICAL FIELD

The present invention relates to a connecting apparatus for an actuating cable such as a shift or selector cable of a manual transmission of a motor vehicle as well as a manual transmission with this connecting apparatus.

### BACKGROUND

In an automatic or manual transmission of a motor vehicle, an actuating cable with a connecting apparatus is used to transmit the shift movement of the shift lever in the motor vehicle to a selector lever on the transmission housing. An example is disclosed in DE 10 2004 013 193 A1.

The connecting apparatus comprises a base body which is fastened on the end of the actuating cable. Provided inside the base body is a receiving body which is supported on the base body by means of two damping elements. A fastening pin is received in the receiving body, which pin is fastened on a selector lever of the transmission. Mechanical movements and vibrations of the selector lever are transmitted to the actuating cable by the damping elements in a damped manner in order to reduce the risk of vibrations being transferred to the shift lever or into the interior of the vehicle. Further improvements are desirable, however, in order to further reduce this risk of vibration transfer.

It is therefore at least one object of the invention to provide a connecting apparatus for an actuating cable on a receiver, which further reduces the risk of vibration being transferred to the shift lever or into the interior of the vehicle. In addition, other objects, desirable features and characteristics will become apparent from the subsequent summary and detailed description, and the appended claims, taken in conjunction with the accompanying drawings and this background.

### SUMMARY

A connecting apparatus for an actuating cable on a receiver according to an embodiment of the invention comprises a base body, a receiving body for connection to the receiver, which is firmly connected to the base body, two separate housing parts, two damping elements, and a holder. The two housing parts surround the receiving body, and the two damping elements are disposed between one of the housing parts and the base body. The holder is displaceably coupled to the housing parts and can be connected to the actuating cable. On actuating the actuating cable, the holder exerts force on a housing part and on a damping element.

The connecting apparatus therefore has two separate housing parts, on which the force is exerted by means of holders. In particular, when actuating the actuating cable, the force, for example, the compressive or tensile force is exerted on a housing part and the damping element located between this housing part and the base body. However, less force or no force is exerted on the second housing part with the holder. In the connecting apparatus, the two housing parts can be moved separately and the damping elements can be loaded separately. Consequently, the loaded part of the connecting apparatus does not influence the unloaded part.

The damping properties of the two damping elements can therefore be different and they can be optimized separately. The damping elements can, for example, have a different Shore hardness. Consequently, the push and pull movement of the actuating cable can be optimized separately so that not only the transmission of vibrations to the shift lever in the vehicle is reduced but also the shift sensation of the shift lever is improved. The arrangement of two separate damping elements and housing parts can also be determined so that the connecting apparatus has digressive characteristics, in particular digressive force-displacement properties.

In one exemplary embodiment, the holder, the housing parts, and the damping elements are arranged in such a manner that when actuating the holder, force is exerted on only one of the housing parts and on only one of the damping elements. For example, in a neutral position the holder can be supported by both housing parts without force being exerted on the housing parts. On actuating the holder, this is only connected to one of the housing parts so that the holder does not exert any force on the other housing part.

In one exemplary embodiment, the holder is displaceable in the direction of a longitudinal axis of the base body. The two housing parts can also be displaceable in the direction of the longitudinal axis of the base body. When the holder is displaced in the direction of the longitudinal axis of the base body, it exerts force on one of the housing parts with the result that this housing part is also displaced in the direction of the longitudinal axis of the base body and thereby exerts force on the damping element.

In one exemplary embodiment, the two housing parts are separated from one another by means of a gap so that they lie on opposing sides of the receiving body.

In a further embodiment of this exemplary embodiment, the holder has two lugs, which are mounted displaceably in the gap between the two housing parts. The two lugs detachably grip the two housing parts so that when actuating the holder, the lugs are in contact with only one of the housing parts. The lugs can extend in the direction of the middle of the body and can be disposed on opposing sides of the receiving holder.

In one exemplary embodiment, the holder is displaceably coupled to the base body so that the holder is displaceably held on the base body. The holder can surround at least one part of an outer edge side of the two housing parts. The shape and arrangement of the holder and the housing parts can therefore be precisely adapted to one another so that when actuating the holder, this reliably exerts force on the housing part.

In one exemplary embodiment, the housing parts each have at least one recess, in which a stop of the base body projects. The housing parts can thus be coupled displaceably to the base body via this stop. The shape and size of the stop as well as the shape and size of the recess are selected so that the housing part is mounted displaceably thereon.

A recess can also be provided for receiving a damping element in the housing parts. This recess can have a length which, in a neutral position, is adapted to the length of the damping element. In this case, one end of the damping element can impact on the base body while the opposite end impacts on the inner side of the recess. The recess therefore has an open side which is closed by the base body. The housing part is displaceably coupled to this stop. In the neutral position the ends of the damping element can exert a small force on the housing part and the base body, whereby the damping element is held in the recess.

In one exemplary embodiment, the stop and the damping element are disposed in a common recess in the housing part. The housing parts can each have a U-shaped recess with two arms, which are connected via a base. One stop on the base body in each case projects into the arms, wherein in a neutral position the damping element extends between the stops, the base of the recess, and the base body. The two stops therefore bring about a more stable mounting of the housing part on the base body.

The embodiments of the invention also provide an apparatus for transmitting tensile and/or compressive forces having a connecting apparatus according to any one of the preceding exemplary embodiments. This apparatus can also have an actuating cable which is connected to the holder. This apparatus for transmitting tensile and/or compressive forces can be used as a shift or selector cable of a manual transmission of a motor vehicle.

The embodiments of the invention also provide a manual transmission of a motor vehicle having an actuating cable with a connecting apparatus according to any one of the preceding exemplary embodiments.

### BRIEF DESCRIPTION OF THE DRAWINGS

The present invention will hereinafter be described in conjunction with the following drawing figures, wherein like numerals denote like elements, and.

FIG. 1a shows a schematic view of an external cable system of a manual transmission;

FIG. 1b shows a perspective view of a connecting apparatus in a neutral position according to a first exemplary embodiment;

FIG. 2 shows a perspective view of the connecting apparatus of FIG. 1 under compressive force;

FIG. 3 shows a detailed view of a damping element of the connecting apparatus of FIG. 2;

FIG. 4 shows a schematic view of the dependence of force and displacement of the connecting apparatus according to the first exemplary embodiment and a comparative apparatus;

FIG. 5 shows a perspective view of a comparative connecting apparatus in a neutral position;

FIG. 6 shows a perspective view of the comparative connecting apparatus of FIG. 5 under compressive force; and

FIG. 7 shows the transverse forces acting on the damping element of the comparative connecting apparatus.

### DETAILED DESCRIPTION

The following detailed description is merely exemplary in nature and is not intended to limit application and uses. Furthermore, there is no intention to be bound by any theory presented in the preceding background or summary or the following detailed description.

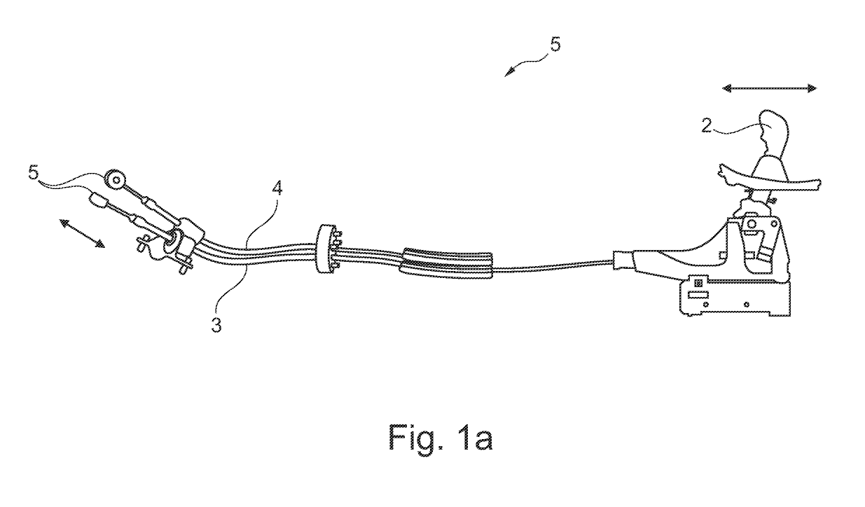

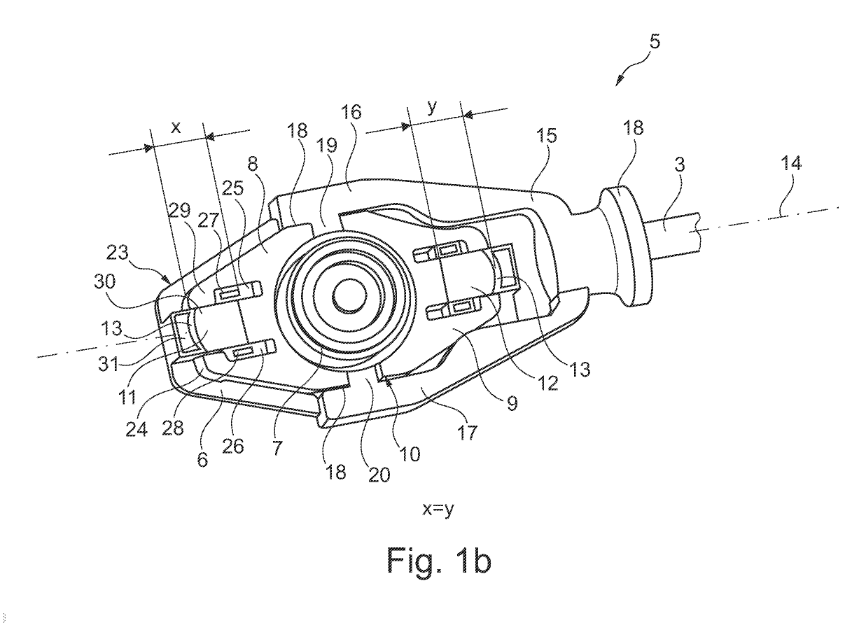

FIG. 1 shows a schematic view of an external cable system of a manual transmission 1. The manual transmission 1 has a shift lever 2, which is located in the interior of a motor vehicle not shown and which is connected to the transmission via a shift cable 3 and a selector cable 4. Each of the shift cable 3 and selector cable 4 has a connecting apparatus 5 at its end. A movement of the shift lever 2 by the driver is transmitted by the shift cable 3 and selector cable 4 to the transmission, as is indicated by the arrows in FIG. 1a.

FIG. 1b shows a perspective view of the connecting apparatus 5 in a neutral position. The connecting apparatus 5 has a base body 6 which is substantially flat and has a rhombic shape. A receiving body 7 is fixedly mounted at the centre of the base body 6 and serves to connect the connecting apparatus 5 to a receiver not shown such as a selector lever of a transmission.

The connecting apparatus 5 further comprises two housing parts 8, 9 which surround the receiving body 7. The housing parts 8, 9 are substantially flat and are disposed on opposing sides of the receiving body 7 and separated from one another by a gap 10. Two damping elements 11, 12 in the form of rubber parts having different Shore hardnesses are furthermore provided. A first damping element 11 is disposed between the first housing part 8 and the outer edge 13 of the base body 6 and a second damping element 12 is disposed between the second housing part 9 and the outer edge 13 of the base body 6. The damping elements 11, 12 are disposed on the longitudinal axis 14 of the base body 6.

The connecting apparatus 5 further comprises a holder 15 which is connected to the actuating cable 3, 4 so that pressure and/or tensile forces can be transferred from the actuating cable 3, 4 to the housing parts 8, 9. Consequently, the holder 15 is displaceably coupled to the housing parts 8, 9 so that when actuating the actuating cable 3, 4, the holder 15 exerts force on one of the two housing parts 8, 9 and its appurtenant damping element 11, 12.

The holder 15 has two arms 16, 17 which are disposed in the direction of the longitudinal axis 14 of the base body 6 and are interconnected via a central part 18. This central part 18 is disposed on the longitudinal axis 14 of the base body 6 and is there connected to the actuating cable 3. The holder 15 is disposed on three side of the base body 6 and the longitudinal side of the two housing parts 8, 9 and is displaceably coupled to the base body 6.

The holder 15 has two lugs 19, 20 which each extend inward from one of the arms 16, 17 so that one lug 19, 20 is disposed in the gap 10 between the housing parts 8, 9 on two opposing sides of the receiving body 7. In a neutral position of the connecting apparatus 5, the lugs 19, 20 are in contact with the first housing part 8 and the second housing part 9. However, the lugs 19, 20 are not fixedly connected to the housing parts 8, 9 but are displaceably mounted in the gap 10.

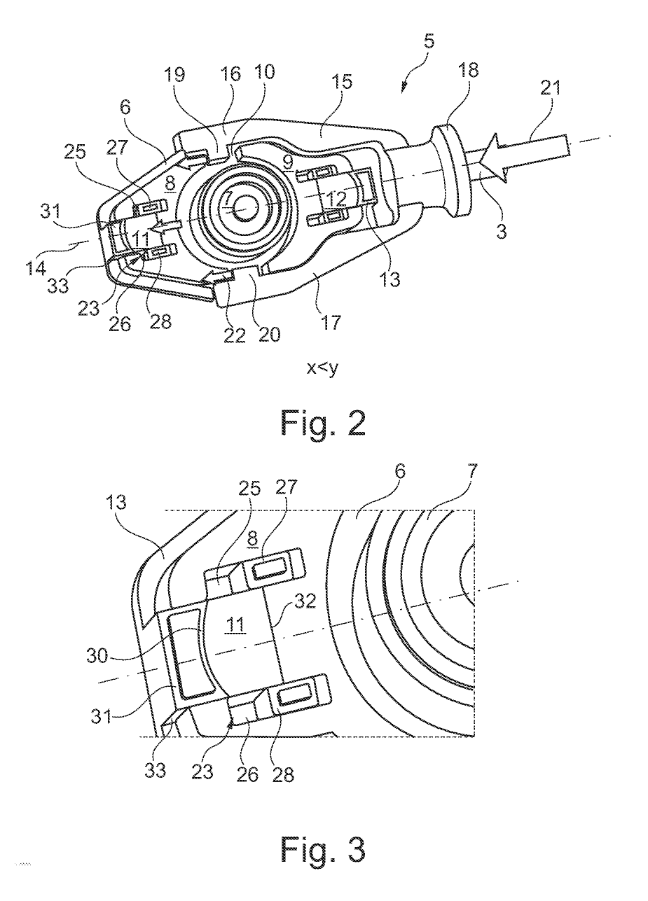

When the actuating cable 3 is actuated with compressive force, the holder 15 is displaced in the direction of the longitudinal axis 14 of the base body 6, as is shown by the arrow 21 in FIG. 2. The lugs 19, 20 of the holder 15 impact against the first housing part 8 and press this in the direction of the longitudinal axis 14 of the base body 6 since the first housing part 8 is displaceably mounted on the base body 6.

The first housing part 8 presses against the first damping element 11 which is disposed between the first housing part 8 and the outer edge 13 of the base body 6 so that the first damping element 11 damps the force. At the same time, the holder 15 moves away from the second housing part 9 so that the holder 15 is no longer in contact with the second housing part 9. The length X of the first damping element 11 is now therefore smaller than the length Y of the second damping element 12. Consequently, there is no interaction between the two damping elements 11, 12 and between the two housing parts 8, 9.

When the actuating cable is actuated with tensile force, the holder 15 is displaced in the opposite direction. The lugs 19, 20 of the holder 15 impact against the second housing part 9 and press the second housing part 9 in the direction of the longitudinal axis 14 of the base body 6 since the second housing part 9 is also displaceably mounted on the base body 6.

The second housing part 9 presses against the second damping element 12 that is disposed between the second housing part 9 and the outer edge 13 of the base body 9 so that the second damping element 12 damps the force. At the same time the holder 15 moves away from the first housing part 8 so that the holder 15 is no longer in contact with the first housing part 8. The length Y of the second damping element 12 is now therefore smaller than the length X of the first damping element 11.

Each housing part 8, 9 has the form of a half-ring having a U-shaped recess 23 in the outer edge 24 of the half-ring centre 29, the recess 23 being open at this outer edge 24. The arms 25, 26 of the U-shaped recess are disposed around stops 27, 28 on the surface of the base body 6. The length and shape of the arms 25, 26 and the stops 27, 28 are selected so that the housing part 8 is displaceably coupled to the stops 27, 28. The damping element 11 is disposed between the stops 27, 28 and the central region of the recess 23 is delimited on its open side 30 with an additional stop 31 on the base body 6. The open side 30 of the recess 23 is also displaceably coupled to the additional stop 31. The damping element 11 is mounted in the recess 23.

In the neutral position shown in FIG. 1, the damping element 11 extends between the stops 27, 28 and between the base 32 of the U-shaped recess 23 and the stop 31 on the base body 6.

When the holder 15 is actuated with compressive force, the first housing part 8 is displaced in the direction of the longitudinal axis 14 of the base body 6 so that the stops 27, 28 are displaced into the arms 25, 26 of the recess 23, the recess 23 is displaced over the outer edges 33 of the stop 31, and the base 32 of the recess 23 presses the damping element 11 onto the additional stop 31. This position is shown in FIG. 2 and in the detailed view of FIG. 3.

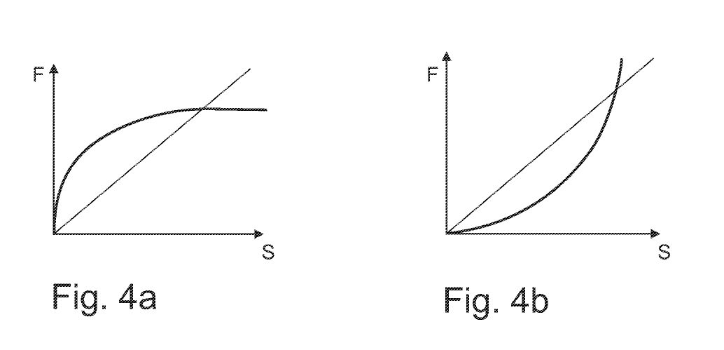

The detailed view in FIG. 3 shows that when the holder 15 is actuated, the area of the recess 23 in which the damping element 11 is located changes since the stops 27, 28 are displaced into the arms 25, 26 so that the damping element 11 is no longer completely laterally delimited by the stops 27, 28. This arrangement as well as the two separate damping elements 11, 12 provides the connecting apparatus 5 with a digressive property as shown in FIG. 4a with a diagram of the relationship of force as a function of displacement.

FIG. 4b shows a diagram of the relationship of force to displacement for a comparative connecting apparatus 40 which has a single damping element 41. This comparative connecting apparatus 40 has a progressive property.

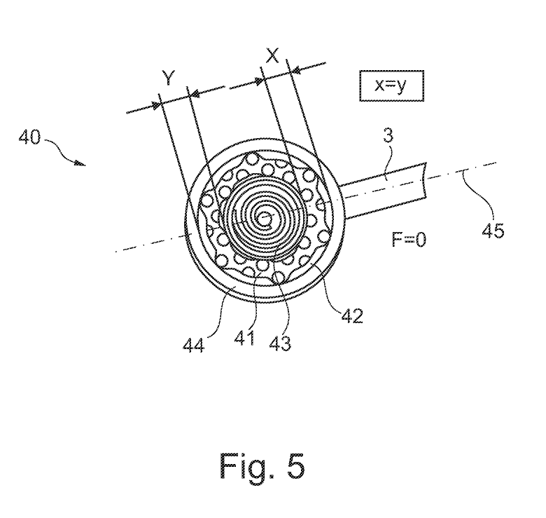

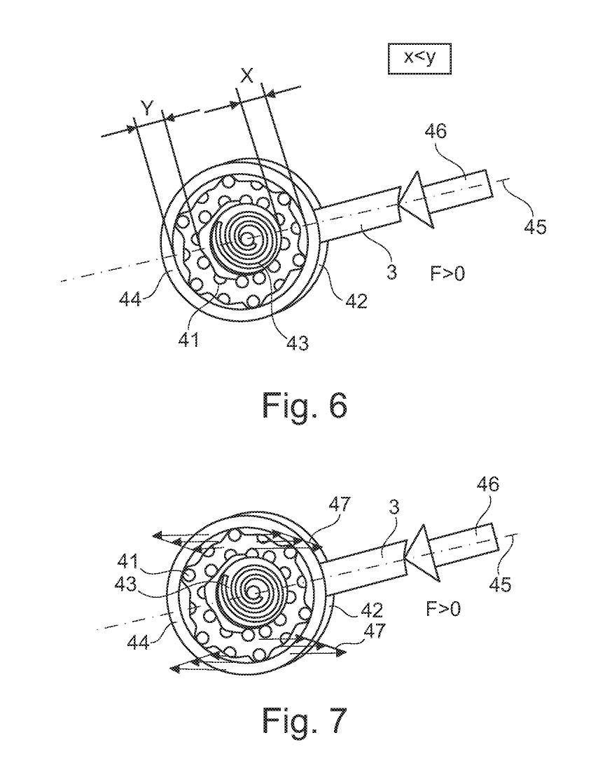

The comparative connecting apparatus 40 is shown in FIG. 5 and FIG. 6. The comparative connecting apparatus 40 also has a base body 42 with a receiving body 43 as in the connecting apparatus 5 according to the invention. However, in the comparative connecting apparatus 40 a single annular damping element 41 is provided which is mounted around the receiving body 43. The damping element 41 is surrounded by an annular holder 44 which is connected to the actuating cable 3.

In the neutral position shown in FIG. 5, the damping element 41 as well as the holder 44 is arranged concentrically around the receiving body 43. The width of the damping element 41 is approximately the same on two opposing sides of the receiving body 43 on the longitudinal axis 45 of the base body 42.

FIG. 6 shows the comparative connecting apparatus 40 when pressure is exerted on the holder 44 as depicted by the arrow 46. The holder 44 is displaced in the direction of the longitudinal axis 45 of the base body 42 and presses the right-hand side of the annular damping element against the receiving body 43 so that the holder 44 and the damping element 41 are no longer arranged concentrically around the receiving body 43. The width of the annular damping element 41 is therefore no longer uniform and transverse forces occur on the opposing sides of the damping element 41, as depicted by the arrows 47 in FIG. 7. In addition, the first region 48 of the damping element 41 on which no force is exerted influences the second region 49 of the damping element 41 on which the force is exerted.

This combination of factors makes it difficult to optimize the force-displacement properties of the comparative connecting apparatus 40. This disadvantage is overcome by the arrangement according to the invention with two separate damping elements 11, 12 which can be actuated separately from one another with two separate housing parts 8, 9.

While at least one exemplary embodiment has been presented in the foregoing summary and detailed description, it should be appreciated that a vast number of variations exist. It should also be appreciated that the exemplary embodiment or exemplary embodiments are only examples, and are not intended to limit the scope, applicability, or configuration in any way. Rather, the foregoing summary and detailed description will provide those skilled in the art with a convenient road map for implementing an exemplary embodiment, it being understood that various changes may be made in the function and arrangement of elements described in an exemplary embodiment without departing from the scope as set forth in the appended claims and their legal equivalents.

What is claimed is:

1. A connecting apparatus for an actuating cable on a receiver, comprising:
a base body;
a receiving body adapted to connect to the receiver that is adapted to connect to the base body;
two separate housing parts that surround the receiving body;
two damping elements that are each disposed between one of the two separate housing parts and the base body; and
a holder that is adapted to displaceably couple to the two separate housing parts and also adapted to connect to the actuating cable,
wherein on actuating the actuating cable the holder is adapted to exert a force on a housing part and on a damping element.

2. The connecting apparatus according to claim 1, wherein the holder, the two separate housing parts, and the two damping elements are arranged in such a manner that when actuating the holder, the force is exerted on only one of the two separate housing parts and on only one of the two damping elements.

3. The connecting apparatus according to claim 1, wherein the holder is displaceable in a direction of a longitudinal axis of the base body.

4. The connecting apparatus according to claim 3, wherein the two separate housing parts are displaceable in the direction of the longitudinal axis of the base body.

5. The connecting apparatus according to claim 1, wherein the two separate housing parts are separated from one another by a gap.

6. The connecting apparatus according to claim 5, wherein the holder comprises two lugs that are mounted displaceably in the gap between the two separate housing parts and which detachably grip the two separate housing parts.

7. The connecting apparatus according to claim 1, wherein the holder is displaceably coupled to the base body.

8. The connecting apparatus according to claim 1, wherein the holder at least substantially surrounds at least one part of an outer edge side of the two separate housing parts.

9. The connecting apparatus according to claim 1, wherein the two separate housing parts each comprise at least one recess in which a stop of the base body is adapted to project.

10. The connecting apparatus according to claim 9, wherein the at least one recess comprises a length that in a neutral position is adapted to a damping length of the damping element.

11. The connecting apparatus according to claim 1, wherein the two separate housing parts each comprise a U-shaped recess with two arms that are connected with a base,
wherein one stop on the base body in each case projects into the two arms and in a neutral position the damping element extends between the stops, the base and the base body.

12. The connecting apparatus according to claim 1, wherein the two damping elements comprise a different Shore hardness.

13. An apparatus for transmitting forces, comprising:
a receiver;
an actuating cable on the receiver;
a base body;
a receiving body adapted to connect to the receiver that is adapted to connect to the base body;
two separate housing parts that surround the receiving body;
two damping elements that are each disposed between one of the two separate housing parts and the base body; and
a holder that is adapted to displaceably couple to the two separate housing parts and also adapted to connect to the actuating cable,
wherein on actuating the actuating cable the holder is adapted to exert force on a housing part and on a damping element.

14. A motor vehicle, comprising:
a manual transmission;
an actuating cable of the manual transmission;
a connecting apparatus, the connecting apparatus:
a base body;
a receiving body adapted to connect to a receiver that is adapted to connect to the base body;
two separate housing parts that surround the receiving body;
two damping elements that are each disposed between one of the two separate housing parts and the base body; and
a holder that is adapted to displaceably couple to the two separate housing parts and also adapted to connect to the actuating cable,
wherein on actuating the actuating cable the holder is adapted to exert a force on a housing part and on a damping element.

15. The motor vehicle according to claim 14, wherein the holder, the two separate housing parts, and the two damping elements are arranged in such a manner that when actuating the holder, the force is exerted on only one of the two separate housing parts and on only one of the two damping elements.

16. The motor vehicle according to claim 14, wherein the holder is displaceable in a direction of a longitudinal axis of the base body.

17. The motor vehicle according to claim 16, wherein the two separate housing parts are displaceable in the direction of the longitudinal axis of the base body.

18. The motor vehicle according to claim 14, wherein the two separate housing parts are separated from one another by a gap.

19. The motor vehicle according to claim 18, wherein the holder comprises two lugs that are mounted displaceably in the gap between the two separate housing parts and which detachably grip the two separate housing parts.

20. The motor vehicle according to claim 14, wherein the holder is displaceably coupled to the base body.
